(19) United States
(12) Patent Application Publication
(10) Pub. No.: US 2005/0195422 A1
(43) Pub. Date: Sep. 8, 2005

(54) System and method for providing a printer maintenance calendar

(76) Inventors: Ben R. Baez, Boise, ID (US); Scott D. White, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/795,190

(22) Filed: Mar. 5, 2004

(51) Int. Cl. G06F 15/00

(52) U.S. Cl. 358/1.14

(57) ABSTRACT

The invention provides a method of providing a printer maintenance calendar for a printer in order to enable a user to plan printer maintenance. The method can include the operation of requesting a copy of the printer maintenance calendar via an activation event received by a maintenance calendar module. The maintenance calendar module can query the printer for a printer maintenance event. The printer maintenance event can be combined into a formatted printer maintenance calendar. The printer can then print the formatted printer maintenance calendar.

### FIELD OF THE INVENTION

The present invention relates generally to printer maintenance.

### BACKGROUND

Before the widespread use of computers, individuals typed documents or drafted artwork manually. An individual drafting an architectural drawing cannot be considered out of service nor can someone who is manually creating a piece of artwork. In contrast, a computer's hardware, software, or network components can fail while users are involved in creating their work product. However, the use of computers has become widespread, and computer users have come to rely on the availability of their computer systems. Not only have computer users come to rely on their computers but users also rely on the printing systems that produce a hardcopy or physical output of their electronic work.

The reliability of a computer printer may be more important in a computer network than that of a printer connected to a single computer workstation due to the multiple users typically sharing a networked printer. When a networked printer is unavailable, an entire group of users can be inconvenienced or stopped from performing their work. In addition, an unscheduled printer failure often means that a printer technician may have to travel to the printer location and repair the printer. Waiting for a technician can consume a considerable amount of time. Frequently, printer users have tight time deadlines that the users are required to meet. Any unscheduled printer downtime or delays can be frustrating and costly from a business point of view.

Printer users can avoid some unscheduled printer downtime through regular maintenance visits from a printer technician. However, these printer maintenance visits are frequently neglected and the general printer maintenance is often not performed. Since printers have hundreds of intricate parts that all work together, the printers are often programmed to stop printing after a specific number of printed pages. A complete printer shutdown can avoid permanent damage to the printer system when it has not been maintained properly. Furthermore, if a maximum number of pages is reached and general maintenance has not been performed, a general cleaning of the printer can improve the printer's performance.

Unfortunately, a printer shutdown or quality-printing problem can be another inconvenience that users have to deal with when the maintenance is not performed in a timely manner. A complete shutdown of a printer because routine maintenance has not been performed can be especially frustrating, particularly when the problem could have been avoided by planning for maintenance.

### SUMMARY OF THE INVENTION

The invention provides a system and method of providing a printer maintenance calendar for a printer in order to enable a user to plan printer maintenance. The method can include the operation of requesting a copy of the printer maintenance calendar via an activation event received by a maintenance calendar module. The maintenance calendar module can query the printer for a printer maintenance event. The printer maintenance event can be combined into a formatted printer maintenance calendar. The printer can then print the formatted printer maintenance calendar.

### BRIEF DESCRIPTION OF THE DRAWINGS

FIG. 1 is a block diagram illustrating a system for providing a printer maintenance calendar in accordance with an embodiment of the present invention;

FIG. 2 is a block diagram illustrating a system for providing a printer maintenance calendar that is connected to a network in an embodiment of the invention.

FIG. 3 is a flow chart depicting a method for providing and printing a printer maintenance calendar in an embodiment of the invention.

FIG. 4 is a flow chart depicting a method for providing a printer maintenance calendar and sending it to a requesting device in an embodiment of the invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

There has been a need for a system and method to help printer users identify when future printer maintenance may be desired. By using such a system and method, printer users can avoid being surprised by printer breakdowns due to neglected maintenance. The present invention can reduce frantic calls to printer support centers made by irate users that have a deadline to meet. In addition, situations where a printer needs a service technician to come and perform emergency maintenance or cleaning can also be reduced. Instead, printer users can use the present invention to schedule maintenance down-time weeks or months in advance and have information available to them about what printer maintenance may be needed for their specific printer in the future.

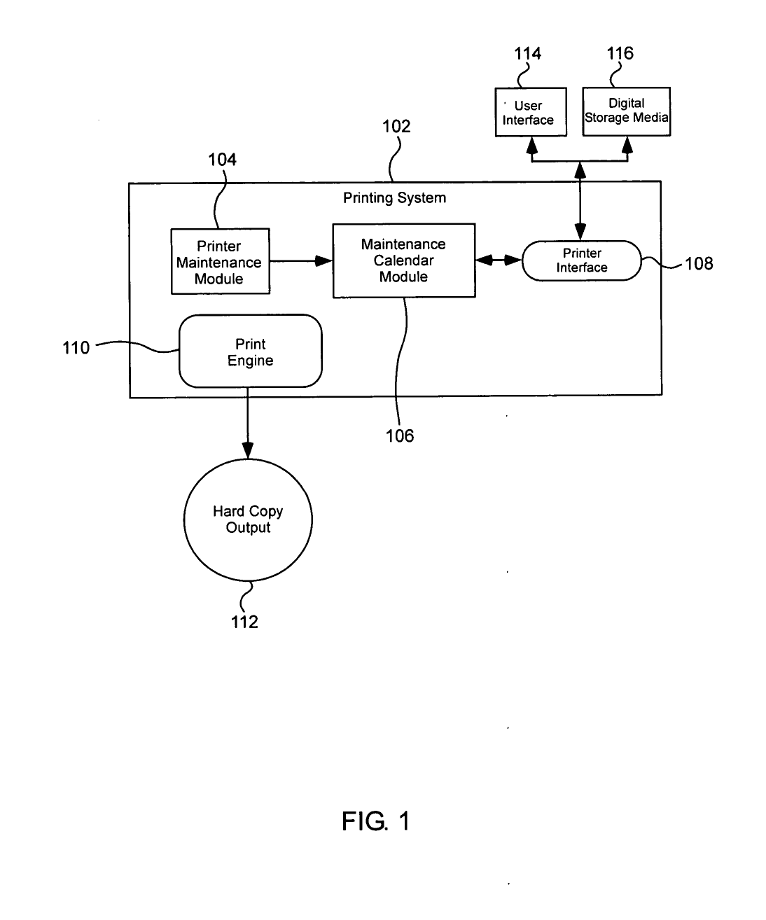

In order to overcome the problems described previously and to provide easily accessible information concerning printer maintenance needs, the present invention includes a system and method for providing a printer maintenance calendar for a printer as illustrated in FIG. 1. In one embodiment, the invention includes a printing system 102 having a printer maintenance module 104. The printer maintenance module can be any type of hardware or software device developed to detect the maintenance needs of a printer and electronically report those maintenance needs.

The maintenance needs of a printer, as reported by the printer maintenance module 104, are defined collectively as printer maintenance events. For example, the printer maintenance module may have hardware sensors connected to parts of the printer that can wear out, break, or become jammed. The sensors can send codes to a central unit that interprets the codes and reports the printer maintenance event. In addition, the printer maintenance module can have software or firmware that tracks the number of pages printed or hours of printer use. This allows the printing system 102 to extrapolate printer usage and provide a suggested maintenance schedule.

A maintenance calendar module 106 can receive an activation event from either a timed event generated internally or a user request. Upon activation, the maintenance calendar module can query the printer maintenance module 104 and collect the printer maintenance event or events that are currently available. The timed activation event may occur at a predetermined point in time such as either at a certain preset date or when maintenance requirements reach a determined state. For example, the maintenance calendar module can automatically generate a timed event after 500 hours of printer operation, when a printer consumable is low, or when a certain replaceable printer part is reported as needing replacement by the printer maintenance module. Alternatively, a user request may occur when a user triggers an input interface (e.g. using a button) to activate the maintenance calendar module.

Yet another alternative is for the maintenance calendar module to periodically request one or more printer maintenance events from the maintenance calendar module. The maintenance calendar module can request printer maintenance events at a pre-determined time, such as when the printer has been powered up, before it is powered down, once every 10 hours of operation, or the like. In other words, a periodic polling system can be used. The maintenance calendar module can then compare the printer maintenance event with the printer's current condition, and update the printer maintenance events in the maintenance calendar module if the printer maintenance events have changed since last requested.

In one embodiment, the printer maintenance module 104 provides the maintenance calendar module 106 with printer-maintenance event data. Printer maintenance event data can comprise one or more printer maintenance events that include the number of pages printed by the printer, the condition of various parts that need to be periodically replaced, the number of hours the printer has been powered-on, and similar data. In addition to service data, the printer-maintenance event data can include the status of printer consumables. Printer consumables include items such as toner, ink, printer maintenance kits, printer drums, printer belts, and printer replacement parts. Each time the maintenance calendar module is activated, the printer-maintenance event data can be sent from the printer maintenance module to the maintenance calendar module, and the maintenance calendar module can be updated to reflect the current state and or usage of the printer.

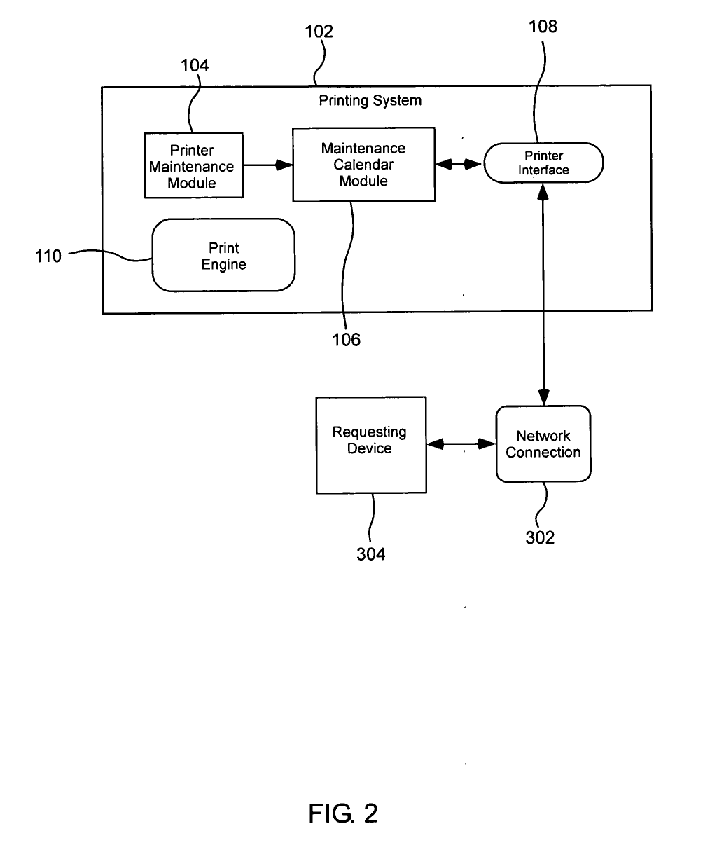

A printer interface 108 can be used as an input or output controller or connection for the maintenance calendar module 106. The printer interface may interconnect the maintenance calendar module and a user interface 114, digital storage media 116, a requesting device 304 (FIG. 2), a network connection 302 (FIG. 2), or other electronic systems for communicating with the maintenance calendar module.

The maintenance calendar module may have additional information pre-programmed or electronically loaded through the printer interface 108 into the maintenance calendar module or manually entered by a user into the maintenance calendar module. This additional information may include printer servicing event data or printer general cleaning event data, such as when the printer was last serviced, how many sheets can be printed before the printer needs to be serviced or cleaned, what types of service are typically performed on various models of printers, and similar information. The printer servicing event data and printer general cleaning event data are subsets of the printer-maintenance event data. The user entered, electronically loaded, or pre-programmed data may be stored in the maintenance calendar module to aid in calculating when maintenance general service or cleaning events may be suggested for the printing system. For example, this data can be used to extrapolate the rate at which pages are printed or consumables are used and to determine when the printer will need a general cleaning or servicing event.

The maintenance calendar module 106 can then combine the user entered or pre-programmed information with the printer maintenance event data into a format that is printable and useful to a user. The maintenance calendar module may also have various types of printer maintenance calendar formats available in its memory or an associated storage device. The information collected from the printing system 102 can be organized into an easy to understand display. The display can take the form of a user selected weekly, monthly, or quarterly calendar. Alternatively, the calendar may be organized in a tabular format. The display formatting can be accomplished with a variety of methods well known to those skilled in the art, such as using software, firmware, or hardware to format the data and send the information to the print engine 110.

The print engine can be generally defined as the type of printing system used to produce a hard copy output 112 of the formatted printer maintenance calendar. For example, the print engine can be a laser printer, an ink jet printer, a bubble jet printer, a photocopier, or another type of print engine known to those skilled in the art. The hard copy output can be a printed copy of the formatted printer maintenance calendar printed on paper or some similar medium.

The printer users may use the information displayed on the printer maintenance calendar to determine when printer servicing and cleaning may be scheduled in the future. The printer users can also check to see if they have missed any past maintenance, decide when the printer may need to be scheduled for downtime, or identify what printer parts may need to be ordered.

The printer interface 108 can be physically or electrically connected to the maintenance calendar module 106, and may include any connection necessary to input data into the maintenance calendar module or output data from the maintenance calendar module concerning the printer maintenance calendar data. One connection to the printer interface can be, but is not limited to, a user interface 114. The user interface can take a variety of forms. On a relatively less expensive printer, the interface may include a button that the user can press to access a hard copy 112 of the printer maintenance calendar. A relatively more expensive printer or copier can include a touch screen panel. The touch screen panel can display portions of the printer maintenance calendar information or the entire calendar. The printer user can also use the touch screen to input information into the maintenance calendar module concerning the printer and its service needs.

Further, a user's device can make a connection to the printer interface 108 allowing the user to transfer the printer maintenance calendar directly to some form of digital storage media 116. Digital storage media can include such formats as a floppy disk, a hard drive, a digital memory device, a portable computer, a handheld computer, or other storage formats in devices known to those skilled in the art. The digital storage media can also be used to supply additional data to the maintenance calendar module 106 through the printer interface 108. The additional data can include printer maintenance event data, upgrades to software or firmware, or similar data that may be desirable to transmit to the maintenance calendar module.

Another connection to the printer interface can be a network connection 302, as illustrated in FIG. 2. A requesting device 304 can request an electronic copy of the printer maintenance calendar from the maintenance calendar module. The requesting device can be any electronic device able to receive digital information from the maintenance calendar module. A requesting device can be a desktop computer, a laptop computer, a Palm Pilot®, a handheld computer, or a proprietary electronic device developed to connect to the printer.

The requesting device can be physically connected to the maintenance calendar module through the printer interface 108, or the requesting device can be wirelessly connected. The wireless connection of the requesting device can be accomplished using a well-known standard such as IEEE 802.11, Bluetooth®, ultra wideband (UWB), or through similar means known to those skilled in the art. The requesting device can also be located remotely from the printer by connecting to the printer through a network connection 302.

The printer maintenance calendar can be sent to the requesting device 304 over the network through an Internet connection, a local area network (LAN), or a wide area network (WAN). This network connection 302 allows printer users connected to the network (directly or wirelessly) to obtain an electronic copy of all or part of the printer maintenance calendar at a location remote from the printer. A contracted printer service organization or printer repair person can also use the network connection to obtain the printer maintenance calendar at a remote location. The printer service organization or printer repair person can use the printer maintenance calendar to obtain information necessary to identify the type of repair or service the printer needs. The printer user may also use the requesting device 304 to send an electronic copy of the printer maintenance calendar to the print engine 110 to be printed.

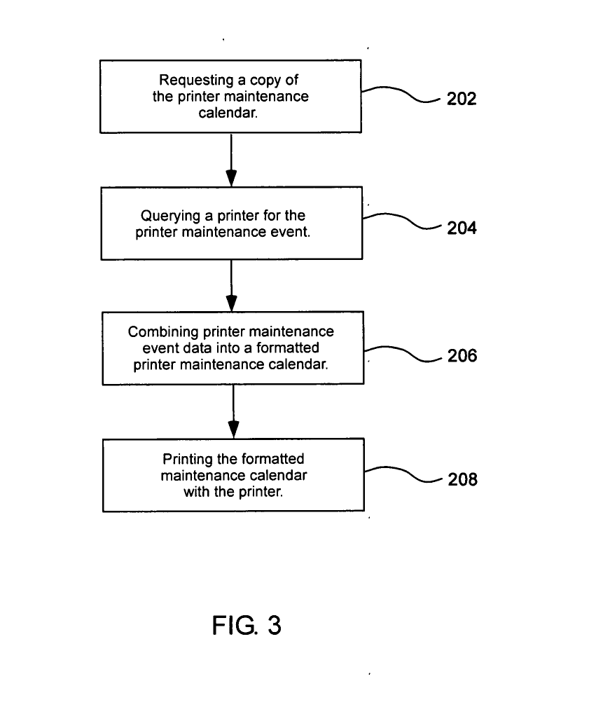

Another embodiment of the invention includes a method of providing a printer maintenance calendar for a printer, as depicted in the flow chart of FIG. 3. The method includes the operation of requesting a copy of the printer maintenance calendar as in block 202. This request can be sent by a user via the user interface or through the printer interface via an external device connected to the printer interface. Upon receiving the request, the maintenance calendar module can be configured to query the printer for a maintenance event as in block 204.

The printer-maintenance event data includes printer-servicing event data. The printer-servicing event data can be information that may have been pre-programmed into the maintenance calendar module. The printer-servicing event data can also be information that is entered into the maintenance calendar module through the user interface or printer interface by a printer user or a printer service person. The printer-servicing event data can further include such information as the last time the printer was serviced, the last time a certain printer part was replaced, and similar events.

The printer-maintenance event data can also include printer general cleaning event data. A printer general cleaning event can be defined as a cleaning of the printing system by a printer user, a printer service person, or some other servicing personnel. The printer general cleaning event data can be entered into the maintenance calendar module and used to calculate when the next general cleaning event may be performed. The calculation can be made by using the data entered into the maintenance calendar module. Using the data, the printer system can extrapolate and provide a suggested maintenance schedule, which can then be placed on the printer maintenance calendar.

The printer-maintenance event data is combined in the maintenance calendar module into a formatted printer maintenance calendar as in block 206. The formatted printer maintenance calendar can then be printed by the printer, as in block 208.

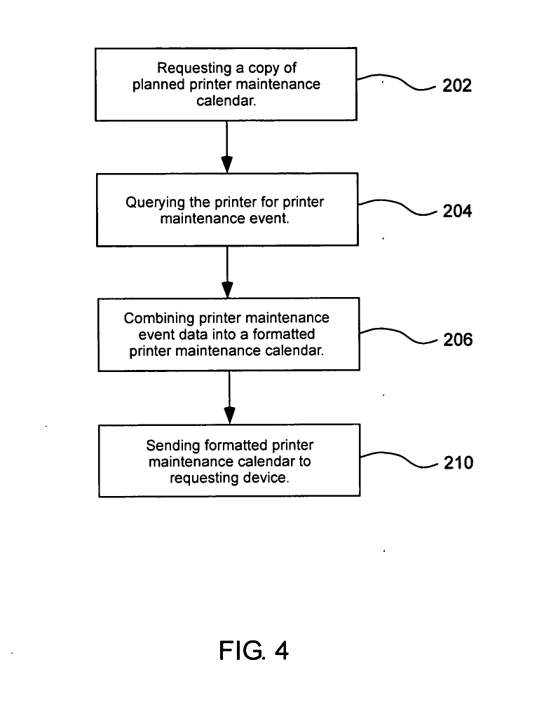

Yet another embodiment of the invention can be a method for providing an electronic version of the printer maintenance calendar, as depicted in the flow chart of FIG. 4. The method includes the operation of requesting a copy of the printer maintenance calendar as in block 202. This request can be done from a requesting device. The requesting device may be connected either to the printer interface or through the network. The connection of the requesting device may be either physical or wireless, using a common wireless protocol such as IEEE 802.11, Bluetooth, or UWB, as discussed above. Upon receiving the request, the printer maintenance module can be configured to query the printer for a printer maintenance event as in block 204. The printer-maintenance event data can then be combined in the maintenance calendar module into a formatted printer maintenance calendar, as in block 206. The formatted printer maintenance calendar can then be sent in a digital format to an external electronic device as in block 210.

The printer-maintenance event data can be updated into the maintenance calendar module as necessary. The data can be updated at pre-programmed intervals, such as at a specific time each day or when the printer is turned on. The data can also be updated by a query from the printer user through the user interface 114 (FIG. 1). The interval at which the data is updated can also be changed by the printer user or printer service person. The interval can be changed through the user interface or through the requesting device 304 (FIG. 2).

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiment(s) of the invention. It will be apparent to those of ordinary skill in the art that numerous modifications can be made without departing from the principles and concepts of the invention as set forth in the claims.

1. A method of providing a printer maintenance calendar for a printer in order to enable a user to plan printer maintenance, comprising the steps of:
requesting a copy of the printer maintenance calendar via an activation event received by a maintenance calendar module;
querying the printer for a printer maintenance event using the maintenance calendar module;
combining the printer maintenance event data into a formatted printer maintenance calendar in the maintenance calendar module; and
printing the formatted printer maintenance calendar with the printer.

2. A method as in claim 1, wherein the step of requesting a copy of the printer maintenance calendar via an activation event further comprises the step of activating the maintenance calendar module via a timed event.

3. A method as in claim 1, wherein the step of requesting a copy of the printer maintenance calendar via an activation event further comprises the step of activating the maintenance calendar module via a user request to the maintenance calendar module.

4. A method as in claim 1, wherein the step of querying the printer with the maintenance calendar module further comprises the step of using the maintenance calendar module to query a printer maintenance module that is configured to detect the printer maintenance event for the printer.

5. A method as in claim 4, further comprising the step of configuring the maintenance calendar module to query the printer maintenance module for the printer maintenance event.

6. A method as in claim 1 further comprising the step of engaging a user interface connected to the maintenance calendar module to access the printer maintenance calendar.

7. A method as in claim 6, wherein the step of engaging a user interface connected to the maintenance calendar module further comprises the step of activating the maintenance calendar module to obtain a printed copy of the printer maintenance calendar.

8. A method as in claim 7, further comprising the step of activating the user interface by pushing a button for the user interface in order to receive a printed copy of the printer maintenance calendar.

9. A method as in claim 7, further comprising the step of engaging the user interface with a touch screen that allows a user to request a printed copy of the printer maintenance calendar.

10. A method as in claim 7, wherein the step of enabling a user interface connected to the printer interface further comprises the step of activating the maintenance calendar module to obtain an electronic copy of the printer maintenance calendar.

11. A method as in claim 10, wherein the step of activating the maintenance calendar module to obtain an electronic copy of the printer maintenance calendar further comprises the step of saving the electronic copy of the printer maintenance calendar on a digital storage medium, wherein the digital storage medium is selected from the group consisting of a floppy disk, hard drive, portable hard drive, digital memory storage device, portable computer, or handheld computer.

12. A method, as in claim 11, further comprising the step of sending printer servicing event data from the digital storage media to the maintenance calendar module through the printer interface.

13. A method as in claim as in claim 6, further comprising the step of sending the formatted printer maintenance calendar from the maintenance calendar module to a requesting device.

14. A method as in claim 13, further comprising the step of sending the formatted printer maintenance calendar to the requesting device, wherein the requesting device is connected to the printer interface.

15. A method as in claim 13, further comprising the step of sending the formatted printer maintenance calendar to the requesting device, wherein the requesting device is remotely connected to the printer interface through a network.

16. A method as in claim 1, further comprising the step of identifying at least one printer maintenance event that includes a printer-servicing event.

17. A method as in claim 16, wherein the step of identifying at least one printer maintenance event further comprises the step of identifying at least one printer servicing event that includes a printer general cleaning event.

18. A method as in claim 7, further comprising the step of scheduling the printer general cleaning event to be performed when a set number of pages are projected to be printed.

19. A method as in claim 1, wherein the step of identifying at least one printer maintenance event further comprises the step of combining one or more printer maintenance events with one or more printer servicing events in the formatted printer maintenance calendar.

20. A method as in claim 1, further comprising the steps of:
requesting at least one printer maintenance event from the maintenance calendar module on a periodic basis;
comparing the printer maintenance event with the printer's current condition; and
updating the printer maintenance event in the maintenance calendar module if the printer maintenance event has changed since it was last requested.

21. A printing system configured to print a printer maintenance calendar for a printer to enable a user to plan printer maintenance, comprising:
a printer maintenance module configured to identify at least one printer maintenance event for the printer;
a maintenance calendar module in communication with the printer maintenance module and configured to format the printer maintenance event into a printer maintenance calendar; and
a printer interface connected to the maintenance calendar module, said printer interface allowing a user to access the printer maintenance calendar in the maintenance calendar module.

22. A printing system as in claim 21, further comprising a print engine in communication with the maintenance calendar module, configured to print the printer maintenance calendar.

23. A printing system as in claim 21, further comprising a user interface, having a display screen configured to receive information from the maintenance calendar module.

24. A printing system as in claim 21, further comprising a requesting device connected to the printer interface to enable a user to request an electronic copy of the printer maintenance calendar.

25. A printing system as in claim 21, wherein the requesting device is further connected to the printer interface through a wireless connection to enable a user to request an electronic copy of the printer maintenance calendar.

26. A printing system as in claim 24, wherein the requesting device further comprises a wireless connection to enable a user to request a printed copy of the printer maintenance calendar.

27. A printing system as in claim 21, wherein the requesting device is selected from the group consisting of a desktop computer, a handheld computer or a laptop computer.

28. A printing system as in claim 21, wherein a requesting device connected to the printer interface remotely through a network to enable a printer repairperson at a remote location to request a printed copy of the printer maintenance calendar at the remote location.

29. An article of manufacture, comprising:
a computer usable medium having computer readable program code embodied therein for providing a printer maintenance calendar for a printer in order to enable a user to plan printer maintenance, the computer readable program code in the article of manufacture comprising:
computer readable program code for requesting a copy of the printer maintenance calendar via an activation event received by a maintenance calendar module;
computer readable program code for querying the printer with the maintenance calendar module for a printer maintenance event;
computer readable program code for combining the printer maintenance event into a formatted printer maintenance calendar in the maintenance calendar module; and
computer readable program code for printing the formatted printer maintenance calendar with the printer.

30. A printing system configured to print a printer maintenance calendar for a printer to enable a user to plan printer maintenance, comprising:
a printer maintenance means for identifying a printer maintenance event for the printer;
a maintenance calendar means in communication with the printer maintenance means for formatting the printer maintenance event; and
a printer interface means connected to the maintenance calendar means for accessing the printer maintenance calendar in the maintenance calendar means.
